(19) United States
(12) Patent Application Publication
(10) Pub. No.: US 2005/0239920 A1
(43) Pub. Date: Oct. 27, 2005

(54) Colored microparticle dispersion, water-based ink, and image forming method

(75) Inventors: Kaori Ono, Tokyo (JP); Takatugu Suzuki, Tokyo (JP)

Correspondence Address: FRISHAUF, HOLTZ, GOODMAN & CHICK, PC, 220 5TH AVE FL 16, NEW YORK, NY, 10001-7708, US

(73) Assignee: KONICA MINOLTA HOLDINGS, INC., Tokyo (JP)

(21) Appl. No.: 11/107,860

(22) Filed: Apr. 14, 2005

(30) Foreign Application Priority Data
Apr. 22, 2004 (JP) JP2004-126470

(51) Int. Cl. C03C 17/00; C09D 11/00

(52) U.S. Cl. 523/160; 523/161

(57) ABSTRACT

A colored dispersion containing water and a plurality of microparticles having a core-shell structure, each microparticle containing: (a) a colorant; (b) a core forming resin; and (c) a shell forming resin, wherein the colorant has a hydrophobicity value (log P) larger than the core forming resin by 8.0 to 12.0.

This application is based on Japanese Patent Application No. 2004-126470 filed on Apr. 22, 2004 in Japanese Patent Office, the entire content of which is hereby incorporated by reference.

### TECHNICAL FIELD

The present invention relates to a colored microparticle dispersion, a water-based ink employing the aforesaid colored microparticle dispersion, and an image forming method employing the aforesaid water-based ink.

### BACKGROUND

In recent years, recording materials and ink materials used for printers, printing presses, markers, and writing implements have been requested to be free of solvents and to be water-based. Particularly, widely employed as water-based recording materials employed for ink-jet recording are those in which an aqueous water-soluble dye solution is used as a main component, or pigment microparticle dispersion is use as a main component.

Employed as water-based inks using water-soluble dyes are those which are prepared in such a manner that glycols and alkanolamines as a humectants, surface active agents to control surface tension, and if desired, thickening agents are added to an aqueous solution of water-soluble dyes mainly classified into acid dyes, direct dyes, and some of food dyes. These water-based inks employing water-soluble dyes are most commonly employed due to high reliability of minimal clogging at the tip of pen and printers. However, bleeding tends to occur on recording paper. As a result, its use has been limited and degradation of recording quality unavoidably occurs. It is difficult to mention that water-soluble dyes, which are penetrated into recording paper and fixed via drying are subjected to dying, resulting in very low lightfastness.

Further, in order to overcome drawbacks such as low waterfastness as well as low lightfastness of water-based inks employing water-soluble dyes, proposals have been made, in which water dispersible resins are colored employing oil-soluble dyes or hydrophobic dyes, for example, in Japanese Patent Publication Open to Public Inspection (hereinafter referred to as JP-A) Nos. 55-139471, 58-45272, 3-250069, 8-253720, 8-92513, 8-183920, and 2001-11347.

Still further, trials have been conducted in which water dispersible resins are not only colored employing oil-soluble dyes or hydrophobic dyes, but colored microparticles are employed which are composed of colorants, and resins covering the colorant, or which are prepared in such a manner that colorant particles composed of colorants and resins are further covered with film forming resins.

In water-based ink employing such colored microparticles, problems occur in which when dyes exist on the surface of particles or on the outside of particles, lightfastness is adversely affected, thus it is difficult to enhance various type of performance such as dispersion stability and ejection stability, required of ink-jet ink.

On the other hand, in pigment ink mainly composed of pigment microparticle dispersion, in order to overcome drawbacks such as insufficient maximum density and poor color reproduction due to bronzing, as well as to enhance lightfastness, dispersion stability, and ejection stability, trials have been conducted in which the surface of pigments particles is covered with film forming resins (refer, for example, to Patent Documents 1-4).

However, those colored particles as well as colored microparticles which are prepared by covering microparticles of colorants such as pigments exhibit possibility of overcoming various drawbacks of conventional water-based ink employing pigments and thereby high recording quality is realized. However, other problems occur in which dispersion stability after production is insufficient and unorthodox operations are required during production. In addition, dispersion stability in water-based media is insufficient. As a result, the present situation is such that stability of the ink, as well as ejection stability does not reach the desired level.

(Patent Document 1) JP-A No. 8-269374

(Patent Document 2) JP-A No. 9-151342

(Patent Document 3) JP-A No. 10-88045

(Patent Document 4) JP-A No. 10-292143

### SUMMARY

An object of the present invention is to provide a colored microparticle dispersion which exhibits excellent dispersion stability, an ink-jet ink employing the same, which exhibits excellent storage stability and ejection stability, as well as an image forming method using the same.

An aspect of the present invention includes a colored dispersion containing water and a plurality of microparticles having a core-shell structure, each microparticle containing:

(a) a colorant;

(b) a core forming resin; and

(c) a shell forming resin,

wherein the colorant has a hydrophobicity value (log P) larger than the core forming resin by the predetermined values.

### DESCRIPTION OF THE PREFERRED EMBODIMENTS

The present invention can be achieved by the following embodiments.
(1) A colored dispersion containing water and a plurality of microparticles having a core-shell structure, each microparticle containing:

(a) a colorant;

(b) a core forming resin; and

(c) a shell forming resin,

wherein the colorant has a hydrophobicity value (log P) larger than the core forming resin by 8.0 to 12.0.
(2) The colored dispersion of the above-described item 1,

wherein the core forming resin has a hydrophobicity value (log P) smaller than the shell forming resin by 1.0 to 3.0.
(3) The colored dispersion of the above-described item 1,

wherein the core forming resin is an acrylate resin or a methacrylate resin.
(4) The colored dispersion of the above-described item 1,

wherein the colorant is an azo dye.
(5) The colored dispersion of the above-described item 1,

wherein each microparticle further comprises a reactive emulsifying agent as a surface active agent.
(6) A water-based ink comprising the colored dispersion of the above-described item 1.
(7) An ink-jet ink comprising the water-based ink of the above-described item 6.
(8) A method of forming an image comprising the step of:

jetting droplets of the ink-jet ink of the above-described item 7 from an ink-jet head onto an ink receiving material based on a digital signal.

The present invention will be detailed below.

(Resin (Polymer))

A resin(or a polymer) used for forming colored microparticles in the colored dispersion of the present invention will be described.

The log P of a colorant used in the coloring particle of the present invention should be from 8.0 to 12.0 larger than the log P of the core forming resin. The resin of the present invention is not limited as long as the above-described log P requirement is satisfied.

For example, the following resins can be listed. A poly (meth)acrylate resin, a polyester resin, a polyamide resin, a polyimide resin, a polystyrene resin, a poly epoxy resin, a polyester resin, an amino resin, a fluorine resin, a phenol resin, a polyuretane resin, a polyethylene resin, a polyvinylchloride resin, a polyvinyl-alcohol resin, a polyallylate resin, a polyether resin, a polyether ketone resin, a polyphenylene sulfide resin, a polycarbonate resin, and an aramid resin.

Among the listed resins, preferable resins are compounds obtained by polymerizing a polymerizable ethylenically unsaturated double bond. Listed examples are, a poly (meth)acrylate resin, a polystyrene resin, a polyethylene resin, a polyvinylchloride resin and a polyvinyl-alcohol resin.

Poly(meth)acrylate based resins are most preferred. Poly(meth)acrylate resins are synthesized via homo- or copolymerization of (meth)acrylate based monomers, and by varying the types of monomers and the composition ratio of those monomers, it is possible to obtain (meth)acrylate based resins exhibiting desired log P.

Poly(meth)acrylate based resins exhibiting log P which is 8.0-12.0 less than log P of colorants employed in the present invention is preferred in view of solubility in solvents and dispersion stability, as well as solubility and affinity for colorants such as dyes and pigments. When dyes, specifically azo dyes, are employed as a colorant, the maximum effects are exhibited.

Other resins can be used in the present invention, in combination with a poly(meth)acrylate resin.

For example, the following resin can be listed.

A polyester resin, a polyamide resin, a polyimide resin, a polystyrene resin, a polyacrylic resin, a polyepoxy resin, a polyester resin, an amino resin, a fluorine resin, a phenolic resin, a polyuretane resin, a polyethylene resin, a polyvinylchloride resin, a polyvinyl-alcohol resin, a polyalylate resin, a polyether resin, a polyether ketone resin, a polyphenylene sulfide resin, a polycarbonate resin, and an aramid resin.

Among these resins, preferable resins are: a resin containing an acetal group as a main functional; a resin containing a carbonate group; a resin containing a hydroxyl group; and a resin containing an ester group.

The aforesaid resins may further have a substituent. The substituent may be a straight chain, a branched chain or a cyclic structure. These resins having the above functional group is commercially available in the market, and they can also be obtained with a conventional method. Moreover, these resins can be obtained by condensation polymerization with other resin or by performing graft polymerization using a light or radiation after introducing an epoxy group into one resin molecule.

It is preferably to use only a poly (meth)acrylate resin in the present invention. The followings are examples of a monomer component which forms a poly (meth)acrylate resin used in the present invention.

(Meth)acrylate, methyl (meth)acrylate, ethyl (meth)acrylate, propyl (meth)acrylate, butyl (meth)acrylate, isopropyl (meth)acrylate, isobutyl (meth)acrylate, t-butyl (meth)acrylate, stearyl (meth)acrylate, 2-hydroxyethyl (meth)acrylate, acetoacetoxy ethyl (meth)acrylate, dimethyl aminoethyl (meth)acrylate, 2-hydroxypropyl (meth)acrylate, di (ethylene glycol) ethyl ether (meth)acrylate, ethylene glycol methyl ether (meth)acrylate, isobornyl (meth)acrylate, ethyl-chloride trimethyl ammonium (meth)acrylate, trifluoro ethyl (meth)acrylate, octafluoro pentyl (meth)acrylate, 2-acetamide methyl (meth)acrylate, 2-methoxy ethyl (meth)acrylate, 2-dimethyl aminoethyl (meth)acrylate, 3-trimethoxysilane propyl (meth)acrylate, benzyl (meth)acrylate, tridecyl (meth)acrylate, 4-hydroxy butyl (meth)acrylate, tetrahydrofurfuryl (meth)acrylate, dodecyl (meth)acrylate, octadecyl (meth)acrylate, 2-diethylamino (meth)acrylate, 2-ethylhexyl (meth)acrylate, cyclohexyl (meth)acrylate, phenyl (meth)acrylate, glycidyl (meth)acrylate, (meth)acryl acid, methyl (meth)acrylate, ethyl (meth)acrylate, propyl (meth)acrylate, butyl (meth)acrylate, stearyl (meth)acrylate, 2-hydroxyethyl (meth)acrylate, aceto acetoxy ethyl (meth)acrylate, benzyl (meth)acrylate, tridecyl (meth)acrylate, dodecyl (meth)acrylate and 2-ethylhexyl (meth)acrylate.

Resins employed in the present invention are synthesized by allowing these to undergo homopolymerization or copolymerization. For example, listed are copolymer resins such as benzyl methacrylate/ethyl acrylate or butyl acrylate, copolymer resins such as methyl methacrylate/2-ethylhexyl methacrylate, copolymer resins such as methyl methacrylate/methacrylic acid/stearyl methacrylate/acetacetoxyethyl methacrylate, or in addition, copolymer resins such as 2-ethylhexyl methacrylate/2-hyrooxyethyl methacrylate.

In view of film forming properties after printing, durability thereof, and suspension forming properties, the number average molecular weight of resins employed in the present invention is preferably 500-100,000, but is most preferably 1,000-30,000.

(Colorants)

Employed as coloring components (namely colorants) in colored microparticles employed in the present invention will now be described. Colorants exhibiting a log P which is 8.0-12.0 more than the log P of resins employed in the present invention, as described herein, may be commonly known dyes and pigments. However, in the present invention, colorants are preferably dyes, but are most preferably oil-soluble dyes. Oil-soluble dyes are ones which are typically soluble in organic solvents having no water-solubilizing group such as carboxylic acid or sulfonic acid, and are insoluble in water. However, dyes are included which exhibit solubility in oil by allowing water-soluble dyes to form salts with a long chain base.

Listed examples of dyes are: an acid dye, a direct dye, a salt forming dye derived form a reactive dye and a long chain alkyl amine. Although the present invention is not limited by them, examples of dyes used in the present invention are as follows:

Valifast Yellow 4120, Valifast Yellow 3150, Valifast Yellow 3108, Valifast Yellow 2310N, Valifast Yellow 1101, Valifast Red 3320, Valifast Red 3304, Valifast Red 1306, Valifast Blue 2610, Valifast Blue2606, Valifast Blue 1603, Oil Yellow GG-S, Oil Yellow 3G, Oil Yellow 129, Oil Yellow 107, Oil Yellow 105, Oil Scarlet 308, Oil Red RR, Oil Red OG, Oil Red 5B, Oil Pink 312, Oil Blue BOS, Oil Blue 613, Oil Blue 2N, Oil Black BY, Oil Black BS, Oil Black 860, Oil Black 5970, Oil Black 5906, Oil Black 5905 (Orient Chemical Co. Ltd.);

Kayaset Yellow SF-G, Kayaset Yellow K-CL, Kayaset Yellow GN, Kayaset Yellow A-G, Kayaset Yellow 2G, Kayaset Red SF-4G, Kayaset Red K-BL, Kayaset Red A-BR, Kayaset Magenta 312, Kayaset Blue K-FL (Nihon Kayaku Co. Ltd.);

FS Yellow 1015, FS Magenta 1404, FS Cyan 1522, FS Blue 1504, C.I.Solvent Yellow 88, 83, 82, 79, 56, 29, 19, 16, 14, 04, 03, 02, 01, C.I.Solvent Red 84:1, C.I.Solvent Red 84, 218, 132, 73, 72, 51, 43, 27, 24, 18, 01, C.I.Solvent Blue 70, 67, 44, 40, 35, 11, 02, 01, C.I.Solvent Black 43, 70, 34, 29, 27, 22, 7, 3, C.I.Solvent Violet 3, C.I.Solvent Green 3 and 7, Plast Yellow DY352, Plast Red 8375 (Arimoto Chemical Co. Ltd.);

MS Yellow HD-180, MS Red G, MS Magenta HM-1450H, MS Blue HM-1384 (Mitsui Chemical Co. Ltd.);

ES Red 3001, ES Red 3002, ES Red 3003, TS Red 305, ES Yellow 1001, ES Yellow 1002, TS Yellow 118, ES Orange 2001, ES Blue 6001, TS Turq Blue 618(Sumitomo Chemical Co. Ltd.); and

MACROLEX Yellow 6G, Ceres Blue GNNEOPAN Yellow O75, Ceres Blue GN, MACROLEX. Red Violet R (Bayer Co. Ltd.).

A metal complex dye disclosed in JP-A Nos. 9-27769, 10-20559 and 10-30061 is also preferably used in the present invention.

A dispersion dye can be used as an oil soluble dye. Although the present invention is not limited by them, examples of dyes used in the present invention are as follows.

C.I.Disperse Yellow 5, 42, 54, 64, 79, 82, 83, 93, 99, 100, 119, 122, 124, 126, 160, 184:1, 186, 198, 199, 204, 224 and 237;

C.I.Disperse Orange 13, 29, 31:1, 33, 49, 54, 55, 66, 73, 118, 119 and 163;

C.I.Disperse Red 54, 60, 72, 73, 86, 88, 91, 92, 93, 111, 126, 127, 134, 135, 143, 145, 152, 153, 154, 159, 164, 167:1, 177, 181, 204, 206, 207, 221, 239, 240, 258, 277, 278, 283, 311, 323, 343, 348, 356 and 362;

C.I.Disperse Violet 33;

C.I.Disperse Blue 56, 60, 73, 87, 113, 128, 143, 148, 154, 158, 165, 165:1, 165:2, 176, 183, 185, 197, 198, 201, 214, 224, 225, 257, 266, 267, 287, 354, 358, 365 and 368; and

C.I.Disperse Green 6:1 and 9.

Further, the following are listed as a preferable oil soluble dye.

Couplers, such as cyclic methylene compounds (e.g., phenol, naphthol, pyrazolone, and pyrazolo triazole), and an open chain methylene compound; p-diamino pyridine, an azomethine dye, and an indoaniline dye.

More preferable dyes are azo dyes such as a mono-azo dyes, a disazo dye, and a tris azo dye. The azo dyes represented with a following general formula (I) also in the above are still more preferable.

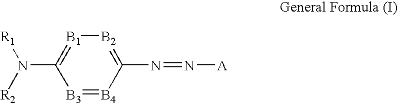

In General formula (I), R1 and R2 each represent a hydrogen atom or a substituent independently.

The substituent represents an aliphatic group, an aromatic group, a heterocyclic group, an acyl group, an alkoxycarbonyl group, an aryloxycarbonyl group, a carbamoyl group, an alkylsulfonyl group, an arylsulfonyl group, or a sulfamoyl group. The hydrogen atom of each of above substituents may be substituted.

R1 and R2 each are preferably a hydrogen atom, an aliphatic group, an aromatic group, and a heterocyclic group, and they are more preferably a hydrogen atom and an aliphatic group.

The following can be listed as examples of an aliphatic group.

An unsubstituted or substituted alkyl group (for example, a methyl group, an ethyl group, a propyl group, an isopropyl group, t-butyl group, a pentyl group, a hexyl group, an octyl group, a dodecyl group, a tridecyl group, a-tetradecyl group, a pentadecyl group); and an unsubstituted or substituted alkenyl groups (for example, a vinyl group, an allyl group).

B1 to B4 each represent —CR3═ or a nitrogen atom, and R3 represents a hydrogen atom or a substituent. The substituent represents the following.

A halogen atom, an aliphatic group, an aromatic group, a heterocyclic group, a cyano group, a carboxyl group, a carbamoyl group, an alkoxycarbonyl group, an aryloxycarbonyl group, a heterocyclicoxycarbonyl group, an acyl group, a hydroxy group, an alkoxy group, an aryl oxy group, a heterocyclicoxygroup, a silyloxygroup, an acyloxy group, a carbamoyloxy group, an alkoxy carbonyl oxygroup, an aryl oxycarbonyl oxygroup, an amino group, an acylamino group, a ureide group, a sulfamoylamino group, an alkoxycarbonylamino group, an aryloxycarbonylamino group, an alkylsulfonylamino group, an arylsulfonylamino group, a heterocyclicsulfonyl amino group, a nitro group, an alkylthio group, an arylthio group, a heterocyclicthio group, an alkylsulfonyl group, an arylsulfonyl group, a heterocyclicsulfonyl group, an alkyl sulfinyl group, an arylsulfinyl group, a heterocyclic sulfinyl group, a sulfamoyl group and a sulfo group. The hydrogen atom of each of above substituents may be substituted.

The following are listed to a preferable substituent. A halogen atom (for example, a chlorine atom, a bromine atom, an iodine atom); an aliphatic group(for example, an alkyl group, an alkenyl group, an alkynyl group); an acyloxy group (for example, an acetyloxy group, an ethylcarbonyloxy group, a butylcarbonyloxy group, an octylcarbonyloxy group, a dodecylcarbonyloxy group, a phenylcarbonyloxy group); a carbamoyl group (for example, an aminocarbonyl group, a methylaminocarbonyl group, a dimethylaminocarbonyl group, a propylaminocarbonyl group, a pentylaminocarbonyl group, a cyclohexylaminocarbonyl group, an octylaminocarbonyl group, 2-ethylhexylaminocarbonyl group, a dodecylaminocarbonyl group, a phenylaminocarbonyl group, a naphthylaminocarbonyl group, 2-pyridylaminocarbonyl group); an alkoxycarbonyl groups(for example, a methyloxycarbonyl group, an ethyl oxycarbonyl group, a butyloxycarbonyl group, an octyloxy carbonyl group, a dodecyloxycarbonyl group); an alkoxy groups(for example, a methoxy group, an ethoxy group, a propyloxy group, a pentyloxy group, a hexyloxy group, an octyloxy group, a dodecyloxy group); an amino group(for example, an amino group, an ethylamino group, a dimethylamino group, a butylamino group, a cyclopentylamino group, 2-ethylhexylamino group, a dodecylamino group, an anilino group, a naphthylamino group, 2-pyridylamino group); an acylamino group(for example, a methylcarbonylamino group, an ethylcarbonylamino group, a dimethylcarbonylamino group, a propylcarbonylamino group, a pentylcarbonylamino group, a cyclohexylcarbonylamino group, 2-ethylhexylcarbonylamino group, an octylcarbonylamino group, a dodecylcarbonylamino group, a phenylcarbonylamino group and a naphthylcarbonylamino group).

“A” represents an aromatic ring or a 5 membered heterocyclic ring.

Listed examples of an aromatic ring are, a benzene ring, a pyridine ring, a pyrazine ring, a pyrimidine ring and a pyridazine ring.

N, O, and S can be listed as examples of a hetero atom in a 5 membered heterocyclic ring.

Listed examples of a 5 membered heterocyclic ring are, a thiophene ring, a furan ring, a pyrrole ring, an imidazole ring, a pyrazole ring, an iso thiazole ring, an isoxazole ring, an oxazole ring, a thiazole ring and a thiadiazole ring.

Preferably, “A” is a nitrogen containing 5 membered heterocyclic ring, and an alicyclic ring, an aromatic ring, or other heterocyclic ring may be condensed with the heterocyclic ring.

Listed preferable examples of a heterocyclic ring are, a pyrazole ring, an imidazole ring, a thiazole ring, an iso thiazole ring, a thiadiazole ring, a benzothiazole ring, a benzoxazole ring and a benzisothiazole ring. Among them, a pyrazole ring, an imidazole ring, an isothiazole ring, a thiadiazole ring and a benzothiazole ring are especially preferable. Each heterocyclic ring may further have a substituent.

It is possible to obtain colorants at the desired log P by variously combining R₁, R₂, B₁-B₄, and A in General Formula (I).

In cases in which the difference in log P between colorants and resins forming colored microparticle dispersion is at most 8.0, protection of colorants by resins and dispersion stability are degraded. On the other hand, when log P is at least 12.0, compatibility of resins with colorants is degraded, whereby problems of incompatibility occur.

(Core-Shell Structure)

In the present invention, a core-shell structure, as described in the present invention, refers to the state in which at least two types of resins and colorants which differ in composition are present in one particle in the form of phase separation. Accordingly, structures are included in which a shell portion completely or partially covers a core portion. Further, a portion of resins which forms a shell may form domains in a particle. Further, one may be acceptable which is composed of a multilayer structure of at least three layers in such a manner that at least one layer having different composition is provided between the core and shell portions.

In the present invention, colored microparticles form a core-shell structure. It is preferable that a core-shell structure is formed in such a manner that colored microparticles in a colored microparticle dispersion are employed to form a core which is covered with resins to form a shell. It is more preferable that the log P of resins employed in the shell portion is 1.0-3.0 less than that of resins employed in the core portion. Such a case results in high dispersion stability, ejection stability when used as ink, and produces prints exhibiting excellent lightfastness.

On the other hand, in cases in which the difference in log P between resins employed in the core portion and shell portion is at most 1.0, covering capability is degraded due to the fact that the shell is brought into the interior of the core. In cases in which the difference in log P is at least 3.0, the shell is not formed on the surface of the core, whereby problems occur in which many new particles which incorporate no colorants are formed.

(Log P)

Log P will now be described. In the present intention, the difference between log P of the above resins and log P of colorants, as well as the difference between log P of resins employed in the core portion and log P of resins employed in the shell portion is critical. A log P value is the parameter which represents the scale of hydrophilicity—hydrophobicity of compounds, wherein as the value increases, hydrophobicity increases, while on the other hand, as the value decreases, hydrophobicity is enhanced. The log P value is a commonly known parameter of compounds, and it is possible to measure or calculate those values.

Further, the values of log P obtained by the calculation formula described below do not completely agree with the partition coefficient of a compound in two solvent systems of n-octanol and water, which can be defined by the following formula, and occasionally, there is some difference between the calculated value and the measured value. Further, even though compounds are different, and in cases of resins, even though microscopic properties or macroscopic properties are supposed to be definitely different, occasionally the resulting values are similar. However, such difference is not so great, and it is possible to describe approximate properties employing those values. As used herein, the lopP value of the present invention is a parameter representing hydrophobicity/hydrophilicity and can be obtained from the partition coefficient capable of being defined by the following formula of a compound in two solvent systems, commonly of n-octanol and water.
log P_{(o/w)}, P_{(o/w)}=Sₒ/S_{w}

Sₒ: solubility of the aforesaid organic compound in n-octanol at 25° C.

S_{w}: solubility of the aforesaid organic compound in water at 25° C.

These are described in detail on pages 73-103 of Kagaku Ryoiki, Extra Edition No. 122, “Yakubutsu no Kozo Kozo Kassei Sokan (Correlation of Structure Activity of Medicines”.

Further, in recent years, methods have been proposed in which log P is obtained via calculation and include several methods such as one based on molecular orbital calculation, a fragment method utilizing Hansch's data, or one utilizing HPLC.

A calculation program employed in the present invention is Project Leader in the calculation package named CAChe of Fuji Communication Co., Ltd. The above method is based on the fragment method described in A. K. Ghost, et al., J Compt. Chem., 9:80 (1988). In cases in which it is possible to obtain log P values employing calculation, it is preferable to use calculated values.

(Resins and Contained Dye Amounts)

In the colored microparticle dispersion of the present invention, resins are blended in ink in an amount of preferably 0.5-50 percent by weight, but more preferably 0.5-30 percent by weight. When the blended amount of resins is in the range of 0.5-50 percent by weight, protection capability of colorants due to resins is exhibited, and storage stability of the ink as a suspension is also enhanced, whereby it is possible to minimize clogging of printer heads caused by an increase in viscosity of the ink due to ink evaporation at the tip of nozzles, as well as due to coagulation of the suspension.

On the other hand, the amount of colorants such as the above dyes and pigments which are blended in ink is preferably 1-30 percent by weight, but is more preferably 1.5-25 percent by weight. When the above colorants are blended in ink in an amount of 1-30 percent by weight, sufficient printing density is realized. In addition, since storage stability of the suspension is improved, it is possible to minimize an undesired increase in the particle diameter due to coagulation.

In the present invention, the total amount of colorants in colored microparticles is preferably from 20 to 1,000 percent by weight with respect to the weight of the total resins. When the amount of colorants is excessively small compared to resins, image density after ink deposition does not increase, while when it is excessively large, the protective capability of resins is not sufficiently realized.

(Surface Active Agents)

During emulsification in the course of preparation of the colored microparticle dispersion of the present invention, it is possible, if desired, to use common anionic emulsifiers (being surface active agents) and/or nonionic emulsifiers (also being surface active agents).

The following can be listed as an aforesaid usual nonion emulsifying agent.

A Polyoxyethylene alkyl ether (e. g., polyoxyethylene lauryl ether and polyoxyethylene stearyl ether); a polyoxyethylenealkyl phenyl ether (e. g., polyoxyethylene nonyl phenyl ether); a sorbitan higher aliphatic acid ester (e. g., sorbitan mono-laurate, sorbitan mono-stearate and sorbitan trioleate); a polyoxyethylene sorbitan higher aliphatic acid esters (e. g., polyoxyethylene sorbitan mono-laurate); a polyoxyethylene higher aliphatic acid esters (e. g., polyoxyethylene mono-laurate and polyoxyethylene mono-stearate); a glycerin higher aliphatic acid esters (e. g., oleic acid mono-glyceride and stearic-acid mono-glyceride); and polyoxyethylene-polyoxypropylene-block copolymer.

Moreover, the following can be listed as an aforesaid anion emulsifying agent.

A higher aliphatic acid salt (e.g., sodium oleate); an alkylarylsulfonic acid salt (e.g., sodium dodecylbenzenesulfonate); an alkylsulfuric acid ester (e.g., sodium lauryl sulfate); a polyoxyethylene alkyl ether sulfuric-ester salt (e.g., sodium polyethoxyethylene lauryl ether sulfate); a polyoxyethylene alkyl aryl ether sulfuric ester salt (e.g., sodium polyoxyethylene nonylphenyl ether sulfate); an alkylsulfosuccinate salt (e.g., sodium mono-octylsulfo succinate, sodium dioctylsulfosuccinate, and sodium polyoxyethylene lauryl sulfo succinate, and the derivatives thereof.

It is preferable that a colored microparticle dispersion having a core-shell structure is prepared in such a manner that after emulsifying a mixture composed of resins and colorants, shell monomers are added, and polymerization reaction is performed.

(Reactive Emulsifiers)

Preferably employed as emulsifiers in the present invention are reactive emulsifiers, other than common anionic emulsifiers (being surface active agents) and/or nonionic emulsifiers (also being surface active agents). Any of the reactive emulsifiers which are either anionic or nonionic may be employed. However preferred are compounds having the substituent of A, B, or C below.

A: straight chain alkyl groups, branched chain alkyl groups, or substituted or unsubstituted aromatic groups having at least 6 carbon atoms

B: nonionic substituents or anionic substituents which result in surface activity

C: radically polymerizable groups

Listed as straight chain alkyl group described in item A are, for example, a heptyl group, an octyl group, a nonyl group, a decyl group, and a dodecyl group, while listed as branched chain alkyl groups are, for example, a 2-ethylhexyl group and the like, while further listed as aromatic groups are, for example a phenyl group, a nonylphenyl group, and a naphthyl group.

As a nonion substituent or an anionic substituent having emulsification ability (surface activity ability) described in the above-described item B, the following can be listed as examples.

A polyethylene oxide, a polypropylene oxide, a polyalkylene oxide of the copolymer.

Listed examples of an anionic substituent are, a carboxy acid group, a phosphoric acid group, a sulfonic acid group, and the salts thereof.

A group substituted with the above-mentioned anionic group at the terminal of an alkylene oxide is also one of the examples of an anionic group.

As a substituent represented by the above-described item B, an anionic group is preferable, and a salt of an anionic group is more preferable.

The radical polymerizable group in the above-described item C is a group which causes polymerization and a cross-linking reaction with a radical active species.

Listed examples are the groups having the following ethylenically unsaturated bond.

A vinyl group, an allyl group, 1-propenyl group, an isopropenyl group, an acrylic group, a meta-krill group, a maleimide group, an acrylamide group and a styryl group.

Preferred as reactive emulsifiers employed in the present invention are the compounds represented by following General Formulas (1)-(3).

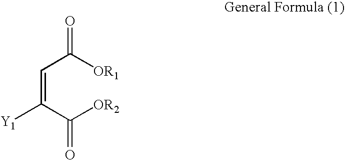

In above General Formula (1), R₁ represents a straight chain alkyl group having 6-20 carbon atoms,a branched alkyl group, or a substituted or unsubstituted aromatic group, and examples include a straight chain alkyl group such as a heptyl group, an octyl group, a nonyl group, a decyl group, a or a dodecyl group, a branched alkyl group such as a 2-ethylhexyl group, and an aromatic group such as a phenyl group, a nonylphenyl group, or a naphthyl group, which are described in above item A. R₂ represents a substituent having a radically polymerizable group and examples include an acryl group, a methacrylic group, and a maleimido group having an ethylenic unsaturated bond, which are described in above item C. Y₁ represents sulfonic acid and carboxylic acid, or salts thereof.

It is possible for a person skilled in the field to synthesize the compounds represented by General Formula (1), employing prior art methods. Further, they are readily available commercially. As examples, listed may be “LUMTEL S-12”, “LUMTEL S-120A”, “LUMTEL S-180”, and “LUMTEL S-180A”, produced by Kao Corp., as well as “EREMINOL JS-2”, manufactured by Sanyo Chemical Industry Co., Ltd.).

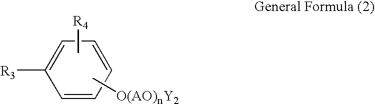

In General Formula (2), R₃ is as defined for R₁ in above General Formula (1), while R₄ is as defined for R₂ in above General Formula (1). Y₂ represents a hydrogen atom as well as sulfonic acid and carboxylic acid or salts thereof. AO represent alkylene oxide.

It is possible for a person skilled in the field to synthesize the compounds represented by General Formula (1), employing prior art methods. Further, they are readily, available commercially. Examples include the NE Series such as “ADEKA REASOAP NE-10” “ADEKA REASOAP NE-20”, or “ADEKA REASOAP NE-30”, and the SE Series such as “ADEKA REASOAP SE-10N”, “ADEKA REASOAP SE-30N”, or “ADEKA REASOAP NE-10”, all produced by Asahi Denka Kogyo K.K., as well as the RN Series such as “Aquaron RN-10”, “AQUARON RN-20”, or “AQUARON RN-30”, “AQUARON RN-50”, and the HS Series such as “AQUARON HS-05”, “AQUARON HS-10”, “AQUARON HS-20”, or “AQUARON HS-30”, and the AQUARON BC Series, all produced by Dai-Ichi Kogyo Seiyaku Co., Ltd.

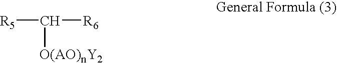

In above General Formula (3), R₅ is as defined for R₁ in aforesaid General Formula (1), while Y₃ is as defined for Y₁ in aforesaid General Formula (1). AO in above General Formula (3) is as defined for AO in aforesaid General Formula (3).

It is possible for a person skilled in the field to synthesize the compounds represented by General Formula (3), employing prior art methods. Further, they are readily available commercially. Listed as examples may be “AQUARON KH-05”, “AQUARON KH-10”, and “AQUARON KH-20”, all produced by Dai-Ichi Kogyo Seiyaku Co., Ltd.

In above General Formulas (2) and (3), the average degree n of polymerization of the alkylene oxide chain (AO) is preferably 1-10. Listed as examples may be above “Aquaron KH-05”, “Aquaron KH-10”, “Aquaron HS-05”, and “Aquaron-HS-10”, produced by Dai-Ichi Kogyo Seiyaku Co., Ltd.

Further, in the present invention, it is preferable that reactive emulsifiers be anionic. Listed as examples may be aforesaid “Adeka Reasoap the SE Series” (produced by Asahi Denka Kogyo K.K.), “the AQUARON HS Series” (produced by Dai-Ichi Kogyo Seiyaku Co., Ltd.), “the LATEMUL S Series” (produced by Kao Corp.) and “the EREMINOL JS Series” (produced by Sanyo Chemical Industries, Ltd.).

In the present invention, the used amount of these reactive emulsifiers is commonly 0.1-80 parts by weight with respect to 100 parts by weight of the total resins, which form cores of the present invention, is preferably 1-70 parts by weight, but is most preferably 10-60 parts by weight.

(Preparation Method of Particles)

The preparation method of colored microparticles according to the present invention will now be described.

The colored microparticle dispersion of the present invention may be prepared employing various methods. For example, resins and colorant as described above are dissolved (or dispersed) in organic solvents and the resulting mixture is emulsify-dispersed in water. After removing organic solvents, in order to minimize coagulation of the above water-based colored microparticle dispersion over an extended period of time, to enhance the stability of microparticles in the form of an ink suspension, as well as to provide desired color tone and glossiness of images formed on media and to provide images with durability such as lightfastness, shells are further formed employing the above colored microparticles as a core. Alternatively, for example, the water-based dispersion of resinous microparticles is previously formed and is mixed with an organic solvent solution in which dyes have been dissolved. Thereafter, dyes are impregnated into resinous microparticles, and shells are formed employing the above colored microparticles as a core. A water-based dispersion of colored microparticles incorporating such colorants and resins tends to not result in coagulation and exhibits desired dispersion stability, whereby it is possible to use it advantageously to form ink-jet ink incorporating the above colored microparticles.

It is preferable that shells be composed of organic resins. Methods for forming shells include one in which a solution, in which resins are dissolved in organic solvents, is gradually dripped and the resins are simultaneously adsorbed on the core surface as they are deposited. In the present invention, it is preferable that colored microparticles incorporating colorants and resins, which are employed as a core, are formed and thereafter, shells are formed in such a way that monomers having a polymerizable unsaturated double bond are added, and in the presence of surface active agents, emulsion polymerization is performed and shells are formed by simultaneously resulting in deposition on the core surface when polymerization is performed.

The following can be listed as examples of a monomer having a polymerizable unsaturated double bond, the monomer covering the colorant particles and forming a shell.

Ethylene, propylene, butadiene, vinyl chloride, vinylidene chloride, vinyl acetate, styrene, (meth)acryl acid ester, a (meth)acryl acid and acrylamide.

Among them, preferable examples are styrene, (meth)acryl acid ester (e.g., ethyl (meth)acrylate, butyl (meth)acrylate, and (meth)acrylate ethylhexyl

In addition to the above-mentioned monomer, the polymerizable unsaturated monomer containing a hydroxyl group in the molecular can also be used.

For example, an ester such as hydroxyalkyl (meth)acrylate can be mixed with a shell forming monomer in a maximum amount of 50 weight % based on the total weight of the shell monomer.

The following monomers can be used in order to increase stability of a shell.

A monomer having a carboxyl group (e. g., acrylic acid, methacrylic acid); and a monomer containing a sulfonic acid group. An ethylenically unsaturated monomer containing a dissociating group exhibiting pKa 3-7 can be added in a smaller amount than the monomer containing the above-mentioned hydroxyl group, and in an amount of 10% or less of the whole shell monomer.

(Emulsification Methods)

Emulsification methods which are employed in the production of the water-based ink of the present invention will now be described. In regard to the water-based ink of the present invention, for example, during production of colorant particles employed as a core, or production of colored core/shell microparticles directly from pigment particles and polymers, it is possible to use various types of emulsification methods. These examples are summarized, for example, in the description on page 86 of “Kinosei Nyukazai•Nyuka Gijutsu no Sinpo to Oyotenkai (Progress and Application of Functional Emulsifiers and Emulsification Techniques) (CMC). In the present invention, it is specifically preferable that emulsifying dispersing apparatuses utilizing ultrasonic waves, high speed rotation shearing, or high pressure are employed.

In emulsifying dispersion employing ultrasonic waves, two methods, a so-called batch system and a continuous system, are usable. The batch system is suitable for the preparation of samples in a relatively small amount, while the continuous system is suitable for samples in a larger amount. In the continuous system, it is possible to use an apparatus such as. UH-600SR (produced by NST Co). In the case of such a continuous system, it is possible to obtain the application time of ultrasonic waves from the capacity of the dispersion chamber/flow rate x circulation frequency. In cases in which a plurality of ultrasonic applying apparatuses is employed, the application time is obtained by adding the application time of each apparatus. In practice, the ultrasonic wave application time is at most 10,000 seconds. When the application time is at least 10,000 seconds, the process load increases, whereby it is necessary to shorten the emulsification dispersion time. Due to that, more than 10,000 seconds is not required. The application time is more preferably in the range of 10-2,000 seconds.

After appropriate selection, employed as emulsifying dispersion apparatuses utilizing high speed rotation shearing are the disper-mixers described on pages 255-256 of “Kinosei Nyukazai•Nyuka Gijutsu no Sinpo to Oyotenkai (Progress and Application of Functional Emulsifiers and Emulsification Techniques) (CMC), the homomixers described on page 251, and the ultra-mixers described on page 256. In these emulsification dispersion apparatuses utilizing high speed rotation shearing, the rotational frequency of stirring blades is critical. In the case of an apparatus having a stator, clearance between the stirring blade and the stator is commonly about 0.5 mm, and since it is not possible to make the clearance extremely narrow, shearing force depends mainly on the peripheral rate of the stirring blade. When the peripheral rate is within 5-150 m/second, it is possible to use them for emulsification and dispersion of the present invention. In cases in which the peripheral rate is low, many cases occur in which even though emulsification time is extended, a decrease in the particle diameter is not realized. In order to achieve 150 m/second, it is required to extremely enhance the performance of motors. The peripheral rate is more preferably 20-100 m/second.

In emulsification dispersion utilizing high pressure, it is possible to use LAB2000 (produced by SMT Co.), and its emulsification•dispersion capacity depends on the pressure applied to the samples. The pressure is preferably in the range of 10⁴−5×10⁵ kPa. Further, if desired, emulsification•dispersion is repeated several times, whereby it is possible to obtain the targeted particle diameter. In the case of excessively low pressure, cases frequently occur in which the targeted particle diameter is not achieved even after repeated emulsification dispersion. In addition, in order to realize a pressure of 5×10⁵ kPa, an excessive load is applied to the apparatus, resulting in no practical operation. The above pressure is more preferably in the range of 5×10⁴−2×10⁵ kPa.

Even though these emulsification•dispersion apparatuses may be used individually, if desired, they may be employed in combinations. Colloid mills or flow jet mixers do not achieve the purposes of the present invention when individually used, but when employed in combination with the apparatuses of the present invention, it is possible to enhance the effects of the present invention in such a manner that it is possible to achieve emulsification-dispersion within a shorter time.

(Particle Diameter)

When the volume average particle diameter of colorant containing colored core/shell microparticles employed for a polymer emulsion type water-based ink in the present invention is at most 5 nm, the effect of enclosing colorants into core/shell polymers decreases due to the fact that the surface area per unit volume becomes excessively large. On the other hand, large particles at a diameter of at least 200 nm tend to cause clogging of heads as well as result in precipitation in the ink, whereby standing stability is degraded. Accordingly, the average diameter of colored microparticles is preferably 5-200 nm, but is more preferably 10-150 nm. When the average particle diameter exceeds 150 nm, the following problems tends to occur. When a water-based ink is prepared employing the above particles, images recorded on glossy media result in pronounced degradation of the feel of transparency. On the other hand, when the average diameter of colored microparticles is less than 10 nm, stability of the colored microparticles is degraded and the storage stability of the ink tends to be degraded. Accordingly, the diameter is most preferably 10-50 nm.

The volume average particle diameter is obtained employing a dynamic light scattering method. In the present invention, it was determined employing ZETA SIZER, produced by Malvern, Inc.

(Ink)

The water-based ink of the present invention incorporates water-based media, particularly water as a medium, and a suspension of colored microparticles into which the aforesaid colorants are sealed. When so prepared, if desired, added to the above suspension are various types of conventional additives known in the art, including humectants such as polyhydric alcohols, inorganic salts, surface active agents, antiseptics, antifungal agents, pH controlling agents, silicone based defoamers, viscosity controlling agents, chelating agents such as EDTA, and oxygen absorbing agents.

Listed examples of a moisturizing agent are as follows. The mixtures of two or more thereof can also be used. A polyhydric alcohol and an ether thereof (e.g., ethylene glycol, propylene glycol, diethylene glycol, triethylene glycol, tetraethylene glycol, polyethylene glycols, glycerin, diethylene glycol diethyl ether, diethylene glycol mono-n-butyl ether, ethylene glycol monomethyl ether, ethylene glycol monoethyl ether, ethylene glycol monobutyl ether, methyl carbitol, ethyl carbitol, butyl carbitol, ethyl carbitol acetate, diethyl carbitol, triethylene glycol monomethyl ether, triethylene glycol monoethyl ether, and propylene glycol monomethyl ether); an acetate; a nitrogen containing compound (e.g., N-methyl-2-pyrrolidone, 1,3-dimethyl imidazolidinone, triethanolamine, formamide and dimethylformamide); and a dimethylsulfoxide, and mixtures of two of more thereof.

The blended amount of these humectants is not particularly limited, and it is possible to blend those in the above water-based ink in an amount of preferably 0.1-50 percent by weight, but more preferably 0.1-30 percent by weight.

Further, in order to maintain stable viscosity of the ink and to improve color formation, it is allowable that inorganic salts are added in the ink. Examples of inorganic salts include sodium chloride, sodium sulfate, magnesium chloride, and magnesium sulfide. When the present invention is practiced, inorganic salts are not limited thereto.

Further, emulsifiers and dispersing agents are not particularly limited. However, in view of exhibition of the effects and effects to retard an increase in the particle diameter in suspension, those having an HLB value of 8-18 are preferred.

Employed as surface active agents may be any cationic, anionic, amphoteric, and nonionic ones. Preferred as emulsifiers or dispersing agents are anionic surface active agents or polymer surface active agents, and anionic surface active agents are particularly preferred. Further, preferably employed as surface tension controlling surface active agents of ink are nonionic surface active agents.

Listed examples of a cationic surface active agent are as follows. An alkylamine salt, an aliphatic quarternary ammonium salt, a benzalkonium salt, benzethonium chloride, a pyridinium salt and an imidazolinium salt.

The following can be listed as examples of an anionic surface active agent. An aliphatic acid soap, an N-acyl-N-methyl glycin salt, an N-acyl-N-methyl-β-alanine salt, an N-acyl glutamate, an alkyl ether carboxylate, an acyl peptide, an alkylsulfonic acid salt, an alkylbenzene sulfonic acid salt, an alkylnaphthalene sulfonic acid salt, a dialkylsulfo succinate salt, an alkylsulfo acetate salt, an a-olefin sulfonic acid salt, an N-acyl methyl taurine, a sulfonated oil, a higher alcohol sulfate salt, a secondary higher alkohol sulfate salt, an alkyl ether sulfate salt, a secondary higher alcohol ethoxysulfate, a polyoxyethylene alkylphenyl ether sulfate, monoglysulfate, a aliphatic acid alkylolamide sulfate salt, an alkyl ether phosphate salt, and an alkyl phosphate salt.

As examples of an amphoteric surface active agent, carboxy betaine, a sulfo betaine, an aminocarboxylic acid salt and an imidazolinium betaine are listed.

The following can be listed as examples of a nonionic surface active agent.

A polyoxyethylene alkyl ether, a polyoxyethylene sec-alcohol ether, a polyoxyethylene alkyl phenyl ether (for example, EMULGEN 911), a polyoxyethylene sterol ether, a polyoxyethylene lanolin derivative, a polyoxyethylene polyoxypropylene alkyl ether (for example, NEWPOL PE-62), a polyoxyethylene glycerine aliphatic acid ester, a polyoxyethylene castor oil, a hydrogenated castor oil, a polyoxyethylene sorbitan aliphatic acid ester, a polyoxyethylene sorbitol aliphatic acid ester, polyethylene glycol aliphatic acid ester, aliphatic acid monoglyceride, Polyglyceryl aliphatic acid ester, sorbitan aliphatic acid ester, propylene glycol aliphatic acid ester, sucrose aliphatic acid ester, aliphatic acid alkanolamide, polyoxyethylene aliphatic acid amide, polyoxyethylene alkylamine, alkylamine oxide, acetylene glycol, and acetylene alcohol.

Listed as other surface active agents are, for example, dispersing agents DEMOL SNB, MS, N, SSL, ST, and P (all trade names) produced by Kao Corp.

In cases in which these surface active agents are employed, they may be employed individually or in combinations of at least two types. By adding these in an amount ranging from 0.001 to 1.0 percent by weight with respect to the total ink, it is possible to control the surface tension of the ink to an optional value. When practiced, the present invention is not limited thereto. In order to achieve storage stability of ink over an extended period of time, antiseptics and antifungal agents may be added to the ink.

Moreover, the following water soluble resins can be used as a high molecular surface active agent. These are preferable in order to improve discharging stability of the ink-jet ink.

Preferable examples of a water soluble resin for the present invention can be list as below.

A styrene-acrylic acids-acrylic acid alkyl ester-copolymer, a styrene-acrylic acids-copolymer, a styrene-maleic acid-acrylic acid alkyl ester-copolymer, a styrene-maleic acid-copolymer, the styrene-methacrylic acid-acrylic-acid alkyl ester-copolymer, a styrene-methacrylic acid-copolymer, the styrene-maleic acid half ester-copolymer, a vinyl naphthalene-acrylic acids-copolymer and a vinyl naphthalene-maleic acid-copolymer.

In addition, JONCRYL (Johnson Co. Ltd.,), which is an acrylic-styrene resin, is listed as an example of a high molecular surface active agent.

These high molecular surface active agents can also used in combination with two or more thereof.

The added amount of each of the above polymer surface active agents is preferably 0.1-10 percent by weight with respect to the total ink, but is more preferably 0.3-5 percent by weight. When the blended amount is less than 0.01 percent by weight, it is difficult to decrease the particle diameter of the suspension, while when it exceeds 10 percent by weight, the particle diameter of the suspension increases or the stability of the suspension is degraded, whereby undesired gelling may occur.

Listed as antiseptics and antifungal agents are aromatic halides (e.g., PREVENTOL CMK and chloromethylphenol), methylenedithiocyanate, halogen-, nitrogen-, and sulfur-containing compounds, and benzisothazoline-3-one (e.g., PROXEL GXL). When the present invention is practiced, it is not limited thereto.

In order to stably maintain ink, pH controlling agents may be added to the ink. Employed as pH controlling agents may be hydrochloric acid, acetic acid, citric acid, sodium hydroxide, and potassium hydroxide without any modification, or being diluted with water.

Further, the aforesaid defoamers are not particularly limited, and it is possible to use commercially available products. Examples of such commercially available products include KF 96, 66, and 69; KS 68, 604, 607A, 602, and 603; and KM 73, 73A, 73E, 72, 72A, 72C, 72F, 82F, 70, 71, 75, 80, 83A, 85, 89, 90, 68-1F, and 68-2F (all being trade names).

The blended amount of these compounds is not particularly limited, but it is preferable that they are blended in the water-based ink of the present invention in an amount of 0.001-2 percent by weight. When the blended amount of the above compounds is less than. 0.001 percent by weight, foam tends to form during ink preparation, and it is difficult to remove foam bubbles within the ink. On the other hand, when it exceeds 2 percent by weight, generation of foam is retarded, however, printing quality is occasionally degraded due to the formation of repellency within the ink during printing. Consequently, it is preferable that the blended amount is controlled to remain within the above range.

(Images)

In the present invention, an ink-jet head which is employed during image formation by ejecting the water-based ink of the present invention employing an ink-jet system may be either an on-demand system or a continuous system. Further, employed as ejection systems are any of the electric-mechanical conversion system (a single cavity type, a double cavity type, a bender type, a piston type, a shared mode type, and a shared wall type), and the electric-thermal conversion system (a thermal ink-jet type and a bubble jet (R) type).

In the image forming method employing the water-based ink of the present invention, ink-jet prints of which images, are formed, for example, on ink-jet image recording media are obtained in such a manner that for example, ink is ejected in the form of droplets based on digital signals from ink-jet heads, employing a printer loaded with a water-based ink and is allowed to adhere to ink receptors.

Employed as ink-jet image recording media may be, for example, any media such as plain paper, coated paper, cast-coated paper, glossy paper, glossy film, or OHP film. Of these, recording media are preferred which have a so-called void layer, being a porous layer. Components or shape of the aforesaid supports are not particularly limited, and examples include those having a three-dimensional structure other than those formed in sheets.

It is possible to use the water-based ink of the present invention other than ink for ink-jet recording as, for example, ink for writing implements such as common fountain pens, ball-point pens, or felt-tip pens. It is also possible to prepare microparticle powder by drying the suspension according to the present invention. It is possible to use the resulting powder as an electrophotographic toner.

### EXAMPLES

The present invention will now be detailed while listing synthesis examples and practical examples, however the present invention is not limited thereto.

(Synthesis of Resins)

### Synthesis Example 1: Synthesis of Polymer P-1

Charged into a separable flask were 25.0 g of methyl methacrylate, 30.0 g of acetacetoxyethyl methacrylate, 30.0 g of stearyl methacrylate, 15.0 g of methacrylic acid, and 150 g of ethyl acetate. After replacing air in the flask with nitrogen gas, the above monomers were completely dissolved while stirring. Subsequently added was 5 g of AIBN (azobisisobutyronitrile) and the resulting mixture was heated employing a heater and refluxed for 4 hours, whereby the ethyl acetate solution of targeted Polymer P-1 was obtained.

Other polymers were synthesized in the same manner as the above synthesis example employing monomer compositions listed in Table 1. Incidentally, the abbreviations and full term of the compounds listed in Table 1 are detailed below.
MMA: methyl methacrylate
SMA: stearyl methacrylate
AAEM: 2-acetacetoxyethyl methacrylate (produced by Nippon
Synthetic Chemical Industry Co., Ltd.)
MAA: methacrylic acid
BnMA: benzyl methacrylate
BNA: n-butyl methacrylate
EHMA: 2-erthylhexyl methacrylate

ST: styrene

TABLE 1

| | Monomer | Monomer | log P of |
|---|---|---|---|
| Polymer No. | Composition | Weight Ratio | Polymer |
| P-1 | MMA/AAEM/SMA/MAA | 25/30/30/15 | 2.94 |
| P-2 | MMA/AAEM/SMA/MAA | 5/30/50/15 | 4.34 |
| P-3 | BnMA/AAEM/SMA/MAA | 25/30/30/15 | 3.37 |
| P-4 | BMA/SMA/MAA | 50/35/15 | 3.91 |
| P-5 | EHMA/MMA/MAA | 60/30/10 | 2.07 |
| P-6 | ST/AAEM/SMA/MAA | 25/30/30/15 | 2.94 |
| P-7 | MMA/AAEM/MAA | 55/30/15 | 0.85 |
| P-8 | ST/SMA | 30/70 | 6.40 |

### Example 1

<<Preparation of Colored Microparticle Dispersion>>

(Preparation of Colored Microparticle Dispersions B-1 as well as B-2-B-9)

Charged into a separable flask were 40.0 g of a solution of Polymer P-1 synthesized in above Synthesis Example 1, 10.0 g of a dye (A-1), ad 120 g of ethyl acetate. After replacing air in the flask with nitrogen gas, the above dye was completely dissolved while stirring. Subsequently, 230 g of an aqueous solution containing 1.5 g of AQUARON KH-05 (produced by Dai-Ichi Kogyo Seiyaku Co., Ltd.) were dripped while stirring. Thereafter, the resulting mixture was emulsified for 300 seconds employing a CLEARMIX W Motion CLM-0, 8W (produced by M Technique Co., Ltd.). Thereafter, ethyl acetate was removed under reduced pressure, whereby a core type colored microparticle dispersion, which impregnated the dye, was prepared. In addition, 0.5 g of potassium persulfate was added, and the resulting mixture was heated to 70° C. employing a heater. Subsequently, a reaction was performed over 5 hours while dripping 10.0 g of methyl methacrylate, whereby Core/shell Type Colored Microparticle Dispersion B-1 was obtained. The average diameter of the colored particles in the resulting colored microparticle dispersion was 30 nm. Incidentally, the average particle diameter is the volume average particle diameter determined employing a laser particle diameter analysis system, produced by Otsuka Electronics Co., Ltd.

Colored Microparticle Dispersions B-2-B-9 were prepared in the same manner as above Colored Microparticle Dispersion B-1, employing the compositions listed in Table 2. Abbreviations and the full name of compounds described in Table 2 are detailed below. Incidentally, in cases in which resins are mixed with cores or shells and used, the average of values obtained by multiplying each of log P with the mixing ratio is designated as the log P of the resins.
SDA: sodium laurylsulfate sulfonate
KH-05: AQUARON KH-05 (produced by Dai-Ichi Kogyo Seiyaku Co., Ltd.)
BL-S: polyvinyl butyral resin (produced by Sekisui Chemical Co., Ltd.)

EMA: ethyl methacrylate

TABLE 2

| | |
|---|---|
| | A-1 |
| 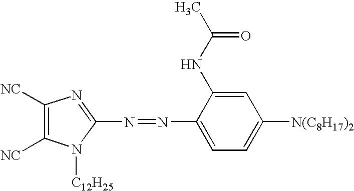 | |

| Colored | | | | | | | Surface | |
|---|---|---|---|---|---|---|---|---|
| Microparticle | Colorant | | Core | | Shell | | Active | |
| Dispersion | Type | log P | Type | log P | Type | log P | Agent | Remarks |
| B-1 | A-1 | 14.0 | P-1 | 2.9 | MMA | 0.8 | KH-05 | Inv. |
| B-2 | A-1 | 14.0 | P-2 | 4.3 | MMA | 0.8 | KH-05 | Inv. |
| B-3 | A-1 | 14.0 | P-3 | 3.4 | MMA | 0.8 | SDS | Inv. |
| B-4 | A-1 | 14.0 | P-4 | 3.9 | EMA | 1.2 | KH-05 | Inv. |
| B-5 | A-1 | 14.0 | P-5 | 2.1 | EMA | 1.2 | KH-05 | Inv. |
| B-7 | A-1 | 14.0 | P-1/BL-S = 1/1 | 2.1 | MMA | 0.8 | KH-05 | Inv. |
| B-8 | A-1 | 14.0 | P-7 | 0.9 | MMA | 0.8 | KH-05 | Comp. |
| B-9 | A-1 | 14.0 | P-8 | 6.4 | MMA | 0.8 | KH-05 | Comp. |

Inv.: Present Invention
Comp.: Comparative Example

<Performance Evaluation Tests>

Each of Colored Microparticle Dispersions (B-1-B-9) was filtered employing a 0.8 μm membrane filter, and foreign matter and coarse particles were removed. In order to evaluate dispersion stability and retaining properties, particle diameter, variation ratio of the particle diameter, and filterability were evaluated.

(Particle Diameter)

Volume average particle diameter was determined employing ZETA SIZER produced by Malvern Inc.

(Particle Diameter Variation Ratio)

After storing each of the colored microparticle dispersions prepared as above at 60° C. for one month, (average particle diameter after storage under heating/(average particle diameter prior to storage under heating)×100 (in percent) was obtained as a particle diameter variation ratio.

(Filterability)

After storing the colored microparticle dispersion at 60° C. for one month, 5 ml was sampled from each of the colored microparticle dispersions. Each of the samples was filtered employing a 0.8 μm cellulose acetate membrane filter and evaluated based on the following criteria:

A: it was possible to filter the total volume

B: it was possible to filter at least half the volume (being a commercially viable level)

C: it was only possible to filter less than half the volume (being a commercially unviable level)

TABLE 3

| | | Particle | | |
|---|---|---|---|---|
| Colored | Particle | Diameter | | |
| Microparticle | Diameter | Variation | | |
| Dispersion | (in nm) | Ratio | Filterability | Remarks |
| B-1 | 30 | 1.1 | A | Inv. |
| B-2 | 42 | 2.4 | A | Inv. |
| B-3 | 26 | 1.8 | A | Inv. |
| B-4 | 31 | 0.9 | A | Inv. |
| B-5 | 39 | 3.2 | A | Inv. |
| B-7 | 53 | 2.1 | A | Inv. |
| B-8 | 91 | 2.7 | C | Comp. |
| B-9 | 136 | 9.5 | C | Comp. |

Inv.: Present Invention
Comp.: Comparative Example

Based on Table 3, it is evident that the colored microparticle dispersions of the present invention result in a minimal particle diameter variation and exhibit excellent filterability.

### Example 2

<<Preparation of Water-based Inks>>

(Preparation of Inks I-1-I-9)

With regard to the colored microparticle dispersions (B-1-B-9), prepared employing the above method, ink was prepared in such a manner that mixing was performed so that the content of colorants was 2 percent, the content of ethylene glycol was 15 percent, the content of glycerin was 15 percent, the content of Surfinol 465 was 0.3 percent, and the rest of the volume was occupied by pure water. The resulting ink was filtered employing a 0.8 μm membrane filter to remove foreign matter and coarse particles, whereby Ink-jet Inks I-1-I-9 were obtained. In order to evaluate dispersion stability and ink retaining properties, as noted above, the particle diameter, particle diameter variation ratio, filterability, and ejection stability were evaluated.

(Particle Diameter)

Volume average particle diameter was determined employing a ZETA SIZER produced by Malvern, Inc.

(Particle Diameter Variation Ratio)

After storing each of the prepared inks at 60° C. for one month, (average particle diameter after storage under heating/(average particle diameter prior to storage under heating)×100 (in percent) was obtained as a particle diameter variation ratio.

(Filterability)

After storing inks at 60° C. for one month, 5 ml was sampled from each of the resulting inks. Each of the samples was filtered employing a 0.8 μm cellulose acetate membrane filter and evaluated based on the following criteria:

A: it was possible to filter the total volume

B: it was possible to filter at least half the volume (being a commercially viable level)

C: it was only possible to filter less than half the volume (being a commercially unviable level).

(Ejection Stability)

Further, ejection stability was evaluated based on the criteria below in such a manner that by employing each of the prepared inks, printing was performed on Konica Photo Jet Paper Photolike QP Glossy Paper (produced by Konica Minolta Corp.), employing an ink-jet printer (Model No. PM-800, produced by Epson Corp.).

A: ejection was performed without any lack of the nozzles Over at least 10 minutes (being a commercially viable level)

B: lack of ejection occurred within 10 minutes (being a commercially unviable level)

TABLE 4

| | Colored | | Particle | | | |
|---|---|---|---|---|---|---|
| | Micro- | Particle | Diameter | | | |
| | particle | Diameter | Variation | | Ejection | Re- |
| Ink | Dispersion | (in nm) | Ratio | Filterability | Stability | marks |
| I-1 | B-1 | 32 | 1.9 | A | A | Inv. |
| I-2 | B-2 | 41 | 6.0 | B | A | Inv. |
| I-3 | B-3 | 29 | 3.8 | A | A | Inv. |
| I-4 | B-4 | 36 | 2.4 | A | A | Inv. |
| I-5 | B-5 | 39 | 5.2 | B | A | Inv. |
| I-7 | B-7 | 56 | 4.9 | A | A | Inv. |
| I-8 | B-11 | 86 | 38.4 | C | B | Comp. |
| I-9 | B-13 | 91 | 18.5 | C | B | Comp. |

Inv.: Present Invention
Comp.: Comparative Example

As can clearly be seen from Table 4, Inks I-1-I-7, employing the colored microparticle dispersion of the present invention, resulted in minimal particle diameter variation ratio, excellent filterability,-as well as excellent dispersion stability and retaining properties. On the other hand, Comparative Inks I-8 and I-9 resulted in a large particle diameter variation ratio after heated storage, as well as formed precipitation and resulted in degraded stability.

In the tests employing the printer, inks of the present invention resulted in no problems with ejection stability, while the comparative inks resulted in degraded ejection stability.

1. A colored dispersion comprising water and a plurality of microparticles having a core-shell structure, each microparticle containing:
(a) a colorant;
(b) a core forming resin; and
(c) a shell forming resin,
wherein the colorant has a hydrophobicity value (log P) larger than the core forming resin by 8.0 to 12.0.

2. The colored dispersion of claim 1,
wherein the core forming resin has a hydrophobicity value (log P) smaller than the shell forming resin by 1.0 to 3.0.

3. The colored dispersion of claim 1,
wherein the core forming resin is an acrylate resin or a methacrylate resin.

4. The colored dispersion of claim 1,
wherein the colorant is an azo dye.

5. The colored dispersion of claim 1,
wherein each microparticle further comprises a reactive emulsifying agent as a surface active agent.

6. A water-based ink comprising the colored dispersion of claim 1.

7. An ink-jet ink comprising the water-based ink of claim 6.

8. A method of forming an image comprising the step of:
jetting droplets of the ink-jet ink of claim 7 from an ink-jet head onto an ink receiving material based on a digital signal.
